(19) United States
(12) Patent Application Publication
(10) Pub. No.: US 2015/0055944 A1
(43) Pub. Date: Feb. 26, 2015

(54) Heated Lamp and Heated Bulb Assembly for Lamp

(71) Applicant: George A. Van Straten, Chassell, MI (US)

(72) Inventor: George A. Van Straten, Chassell, MI (US)

(21) Appl. No.: 13/972,762

(22) Filed: Aug. 21, 2013

(51) Int. Cl. H05B 3/00

(52) U.S. Cl. CPC H05B 3/0042; H05B 3/009
USPC 392/426

(57) ABSTRACT

A heated lamp is provided having a lamp housing, a lens, a thermal reflector, a heating wire, at least one insulator, a light bulb, and a thermostat. The lens is affixed to the housing defining a chamber there between. The thermal reflector is provided in the housing and is spaced from the lens. The heating wire is provided between the reflector and the lens. The at least one insulator is associated with the reflector and is configured to support the heating wire circuitously about the reflector and operative to heat the lens responsive to electrical current being delivered through the wire. The light bulb is carried by the housing between the lens and the reflector. The thermostat is electrically coupled with the heating wire operative to regulate temperature of the heating wire responsive to electrical current being delivered through the wire. A heated light bulb assembly is also provided.

### TECHNICAL FIELD

This disclosure pertains to heated lamps and heated light bulb assemblies for lamps. More particularly, this disclosure relates to apparatus for melting snow and ice and removing condensation from lenses of lights and lighting systems for mobile and stationary applications.

### BACKGROUND OF THE INVENTION

Techniques are known for heating lamps and lighting systems. One technique involves providing a heating wire on a back surface of a cover element provided over a vehicle light. However, such a system does not necessarily provide thermal protection for overheating. Secondly, such a system does not necessarily provide a lens heater contained within a lamp housing spaced proximate a thermal reflector. Thirdly, such a system does not necessarily provide an ability to modify an existing lamp by merely replacing an existing lamp bulb with a bulb assembly that heats the lens sufficient to melt snow and/or ice from the lens. Finally, the recent adoption of LED lighting systems, which generate very little heat, increases the problem of snow and ice accumulating on the lens of such a lighting system. Accordingly, improvements are needed to better enable removal of ice, snow and condensation from lenses of lights and lighting systems.

### SUMMARY OF THE INVENTION

Lamps, lights and bulbs are provided with a heating wire that heats a lens provided between a respective bulb and an environment including inclement weather that can cover the lens with snow, ice, or vapor. By heating the lens, accumulation of snow, ice, or vapor is mitigated or eliminated from a surface of the lens, thereby enabling light to transmit through the lens. Applications include lamps and bulbs on conveyance devices, including vehicles, boats, planes, and trains, as well as sedentary structures, such as lamp posts, street lights, railroad crossing markers and lights, and airport ground and runway lighting systems.

According to one aspect, a heated lamp is provided having a lamp housing, a lens, a thermal reflector, a heating wire, at least one insulator, a light bulb, and a thermostat. The lens is affixed to the housing defining a chamber there between. The thermal reflector is provided in the housing and is spaced from the lens. The heating wire is provided between the reflector and the lens. The at least one insulator is associated with the reflector and is configured to support the heating wire circuitously about the reflector and operative to heat the lens responsive to electrical current being delivered through the wire. The light bulb is carried by the housing between the lens and the reflector. The thermostat is electrically coupled with the heating wire operative to regulate temperature of the heating wire responsive to electrical current being delivered through the wire.

According to another aspect, a heated light bulb assembly is provided having a bulb, a thermal reflector, a heating wire, and a thermal resistor. The bulb has a base configured to be received in a socket of a light fixture. The thermal reflector is carried by the base. The heating wire is provided along an inner surface of the reflector having end portions received within the base and electrically coupled with bulb contacts provided in the base. The thermal resistor is electrically coupled with the heating wire operative to regulate temperature of the heating wire responsive to electrical current being delivered there through.

### BRIEF DESCRIPTION OF THE DRAWINGS

Preferred embodiments of the disclosure are described below with reference to the following accompanying drawings.

FIG. 1 is an exploded perspective view from above of a heated vehicle tail light assembly according to one aspect.

FIG. 2 is a front elevational view of the heated vehicle tail light assembly of FIG. 1 with the lens removed for viewing and not showing the electric cable wiring.

FIG. 3 is side elevational view of the heated vehicle tail light of FIGS. 1 and 2 with the lens removed.

FIG. 4 is a perspective view from above of a heated light bulb assembly according to another aspect.

FIG. 5 is a side elevational view of the heated bulb assembly of FIG. 4.

FIG. 6 is a plan view of the heated light bulb assembly of FIGS. 4-5.

FIG. 7 is a side elevational view of the heated bulb assembly of FIG. 7.

FIG. 8 is an exploded perspective view from below of the heated light bulb assembly of FIGS. 4-7.

### DETAILED DESCRIPTION OF THE PREFERRED EMBODIMENTS

This disclosure is submitted in furtherance of the constitutional purposes of the U.S. Patent Laws “to promote the progress of science and useful arts” (Article 1, Section 8).

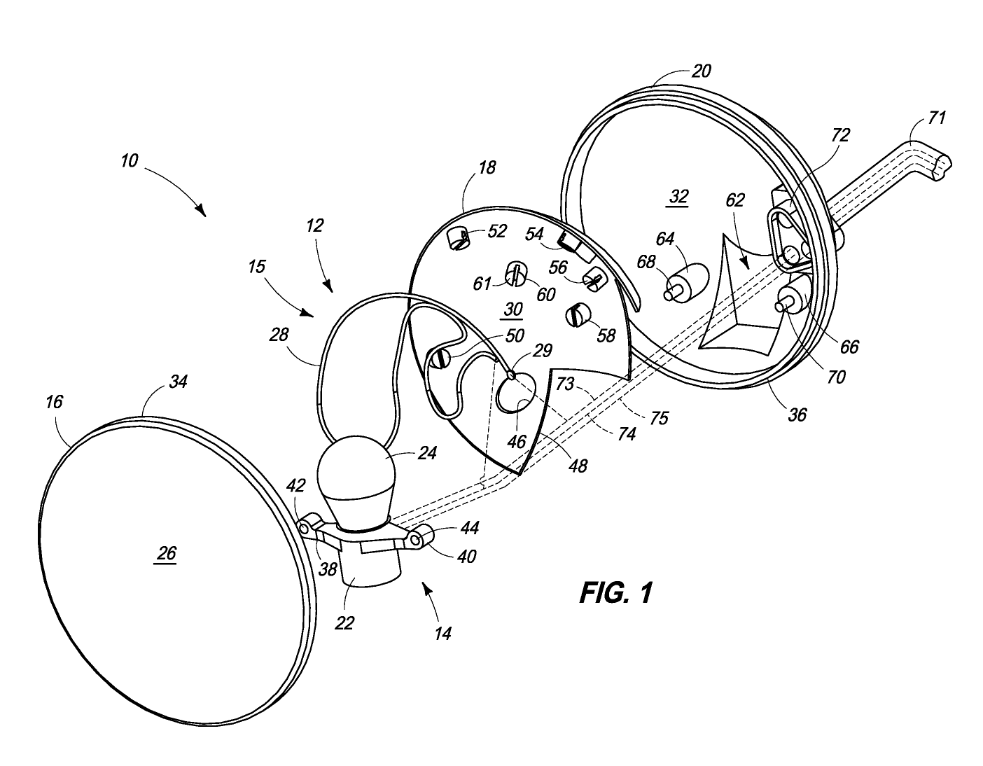

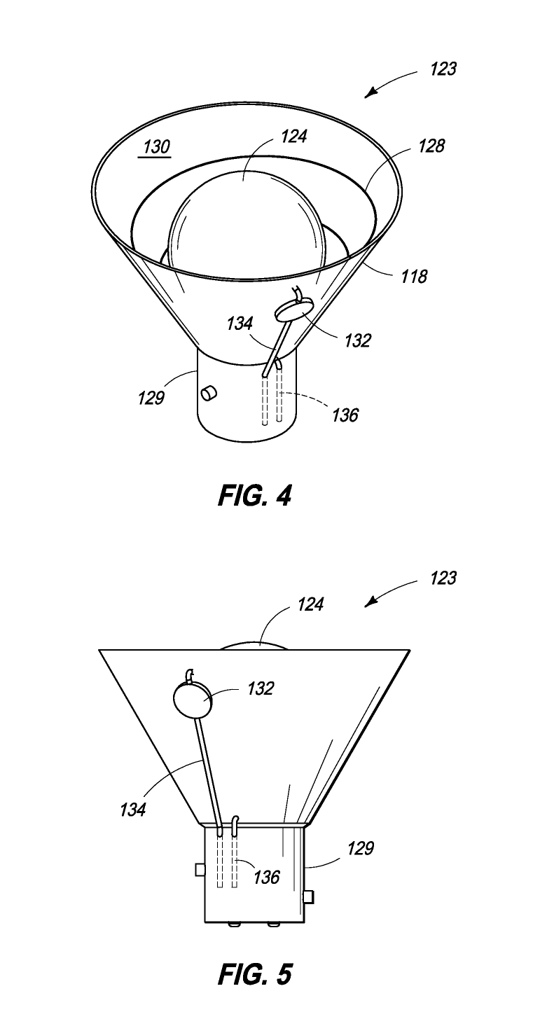

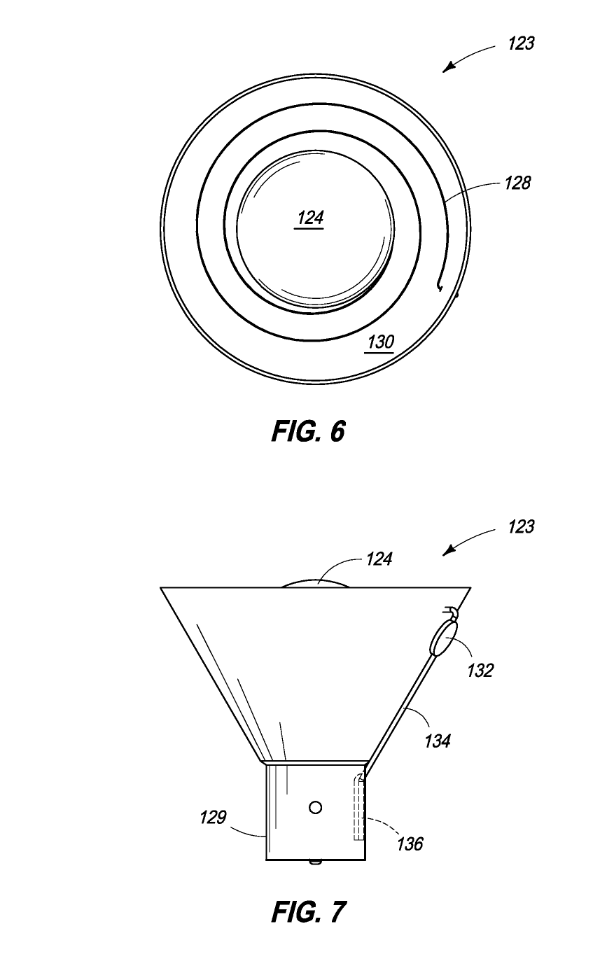

In FIG. 1, a representation of an illustrative heated lamp in the form of a heated tail light assembly is shown and identified by reference numeral 10. More particularly, heated light assembly, or lamp 10 in one implementation is realized by a heated tail light assembly that is affixed to a rear surface or bumper of a vehicle, such as a truck or trailer (not shown). An electrical wiring harness (not shown) from the vehicle provides power to operate the light and heat the light assembly in an effort to remove presence of ice in the form of snow, graupel, hail or frost from a lens surface on the tail light assembly. Optionally, heated lamp 10 can be any of a number of lamps or lights, including side marker lights, head lights, cab lights, brake lights, or any other form of light on any type of conveyance or vehicle including ATVs, snowmobiles, boats, planes, cars, trucks, trains and other forms of transportation requiring a lens heater for removing accumulated snow and/or ice on operating lights associated with the conveyance. Furthermore, heated lamp 10 can be used on other lighting systems including sedentary structures, such as lamp posts, street lights, railroad crossing markers and lights, and airport ground and runway lighting systems. Furthermore, the embodiment depicted in FIGS. 4-8 can also be used on such lighting systems.

FIGS. 1-3 show a tail lamp implementation for heated lamp 10 suitable for use on the rear bumper of a tractor trailer, a vehicle bumper, or a rear body surface. As shown in FIG. 1, a lens heater 12 is provided within a chamber, or cavity 15 and is operative to heat a lens 16 in order to remove snow, ice or condensation that has accumulated on lens 16 and might otherwise obstruct light transmission through lens 16. A thermal, or radiant reflector 18 is received within a lamp housing, or body 20. A lamp assembly 14, including a lamp socket 22 and a lamp bulb 24, are then mounted to housing 20, in front of reflector 18. A heating wire 28 of lens heater 12 is then mounted to reflector 18 and lens 16 is secured to housing 20, encasing respective components therein. In assembly, face portion 26 of lens 16 transmits light from bulb 24, as well as heat from bulb 24 and heated wire 28. Lens 16 is secured to housing 20 with a pair of snap-fit complementary flanges 34 and 36, respectively. Lens 16 and housing 20 can optionally be secured to housing 20 with a plastic weld, or using complementary threaded rim portions on lens 16 and housing 20. Optionally, a lens retainer ring (not shown) can be used to secure lens 16 to housing 20. Further optionally, fasteners can be used to secure lens 16 to housing 20.

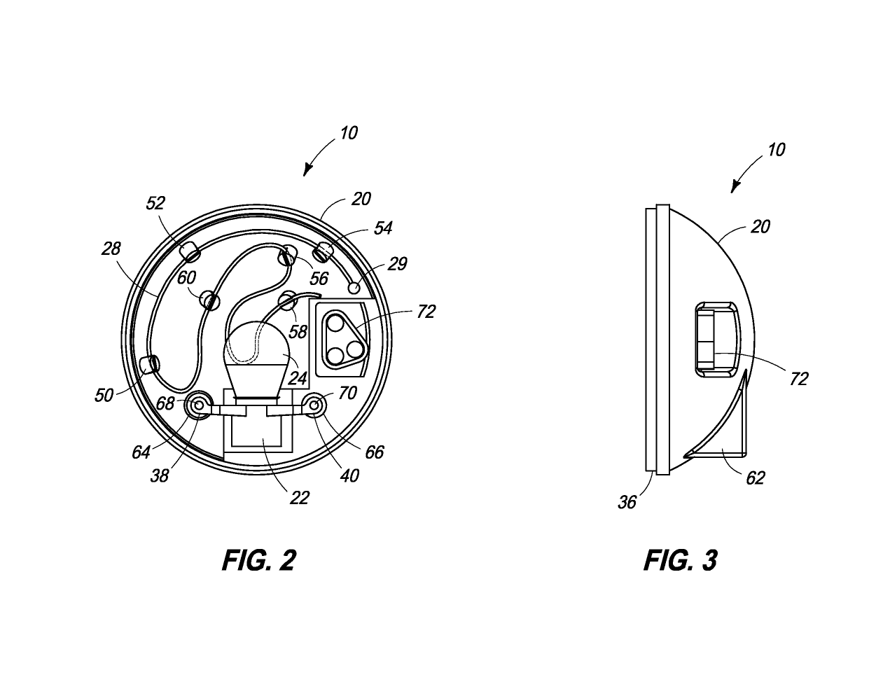

As shown in FIG. 1, lamp socket 22 includes a pair of wings, or arms 38 and 40, each having a respective aperture 42 and 44. Wing arms 38 and 40 are made from a rubber material. Integrally molded bosses 64 and 66 are provided on back wall 32 of housing 20, each including an integrally formed stud, or post 68 and 60, respectively. According to one construction, housing 20 (including bosses 64 and 66 and pins 68 and 70) are formed from injection molded plastic. Optionally, any suitable structural material can be used including metal or composite materials. In assembly, pins 68 and 70 are received through apertures 42 and 44 with an interference fit, wherein the rubber of wings 38 and 40 is urged open to receive pins 68 and 70 in a tight fit-up, as shown in FIGS. 1 and 2. In assembly, an aperture 46 in reflector 18 provides clearance for boss 64. Likewise, a cutout portion 48 in reflector 18 provides clearance for lamp socket 22 when received within housing recess 62.

FIGS. 1 and 2 show heating wire 28 configured in a serpentine, or circuitous pattern within lamp 10 and affixed in spaced-apart and fixed relation to a front reflective surface 30 (see FIG. 1) of reflector 18. More particularly, an array of spaced-apart thermal insulating studs, or isolators 50, 52, 54, 56, 58 and 60 are mounted to reflector 18. In one case, each stud is made from ceramic material and has a stepped-down diameter (not shown) on a proximal end abutting with reflector 18, and reflector 18 has a complementary aperture through which the stepped-down diameter of the stud is received and secured with a threaded faster (within a complementary threaded bore in the stud). Optionally, each stud can be affixed with adhesive or cement to surface 30 of reflector 18. Each stud 50, 52, 54, 56, 58 and 60 includes a slot, or wire slit 61 in a distal end and oriented to support a segment of heating wire 28 in the depicted serpentine configuration. Heating wire 28 comprises a circuitous wire carried in conformably spaced and proximate relation from a thermally and optically reflective surface 30 of the reflector 18.

Lamp socket 22 and lens heater 12 of FIG. 1 receive a supply of DC electric current from an electrical cable 71 led from a vehicle wiring harness (not shown). Cable 71 has an insulated outer cover with three conductive wires 73-75 comprising respectively a ground wire, a positive charge (+) tail light wire, and a blinker wire 75. Ground wire 73 electrically couples with thermistor 29 on wire 28 and lamp socket 22 via a y-splitter. Tail light wire 74 electrically couples with an opposite end of heating wire 28 (than thermistor 29) and lamp socket 22 via a y-splitter. Blinker wire 75 electrically couples with lamp socket 22. In one case, an insulating cover of cable 71 is stripped back and individual wires 73-75 are fed through three individual ports in an integrally molded port 72 of housing 32. An end portion of insulating cover for cable 71 (and neighboring portions of wires 73-75 are then affixed to port 72 by inserting epoxy into cavities provided on both sides of port 72, capturing cable 71 and wires 73-75 therein.

Reflector 18 of FIGS. 1 and 2 is a reflector of both light and thermal (radiant) energy. In one case, reflector 18 is made from injection molded plastic that receives a layer of chrome plating on surface 30. Optionally, reflector 18 can be made from one or more thin pieces of steel, stamped steel, or chromed steel. Other suitable reflective materials can also be used optionally. As shown, reflector 18 comprises a parabolic reflector configured to focus light emanating from bulb 24 for delivery through transparent or translucent lens portion 26 of lens 16. Lens portion 26 may include one or more prisms in portion 26 configured to further concentrate and direct transmission of light from heated lamp 10 pursuant to a desired output pattern.

In one case, heating wire 28 of FIGS. 1 and 2 comprises a Nichrome heating wire (or Nichromium wire) with a thermistor physically crimped to one end of the wire to provide an electrically conductive connection. Optionally, a PTC thermistor alloy resistance wire can be substituted for wire 28 and thermistor (or thermal resistor) 29. Further optionally, one or more conductive traces made from Indium Tin Oxide (ITO), a heat resistant film, can be deposited as a thin film directly onto surface 30 of reflector 28 (or on surface 130 of cone 118 of FIGS. 4-8), or is deposited onto a layer that is subsequently adhesively affixed onto such surfaces. One suitable optional wire is sold as PTC Thermistor Alloy Resistance wire, sold by Senphus, Jiangyin Senphus Electrical Material Co., Ltd., No. 8, Taoyuan Rd., Chengchang Industrial Park, Huangtu Town, Jiangyin City, Jiangsu Province, China. Optionally, thermistor 29 can be replace with any form of thermostat, or with a thermocouple, or resistance temperature detector (RTD) and associated control circuitry, or other thermostat capable of limiting maximum heat output and providing thermostatic control to activate heat delivery from wire 28 to lens 26.

As shown in FIG. 3, heated lamp 10 is affixed to a vehicle with fasteners, such as fasteners that secure into structural recess 62 of housing 20. Optionally, housing 20 can be formed in a vehicle body, or contained within the body where it is mounted.

FIGS. 4-8 depict another aspect comprising a heated light bulb assembly 123 usable in an existing vehicle, structure, conveyance, or lamp post/fixture for melting snow or ice, and removing vapor from a lens through which the bulb is radiating visible (or other forms of) light. More particularly, an existing incandescent lamp bulb or heat lamp bulb is modified with the addition of a frustoconical thermal (or radiant) reflector 118 in which a helical heating wire 128 is supported along an inner thermally (and optically) reflective conical surface 130. As shown in FIGS. 4, 5, and 7, electric current is delivered from the base 129 of bulb through conductive metal leads 134 and 136, up through wire 128 and thermistor 132. A pair of small notches are formed in a top edge of base 129 to facilitate passage of leads 134 and 136 inside of base 129 where they are electrically coupled with respective conductive contacts on base 129, such as via brazing or mechanical affixation. Insulation (not shown) is provided about leads 134 and 136 where they pass through such notches in order to prevent leads 134 and 136 from shorting out across base 129. In operation, thermistor 132 limits and prevents overheating of wire 128 resulting from current flow. In combination, bulb 124 is a heat-lamp-type bulb which further delivers heat to a lamp fixture having a lens on which snow and/or ice is otherwise accumulating. In one case, conductive lead 134 is formed from two discrete segments joined together by thermistor 132 which is crimped onto both segments, thereby joining them together electrically and mechanically.

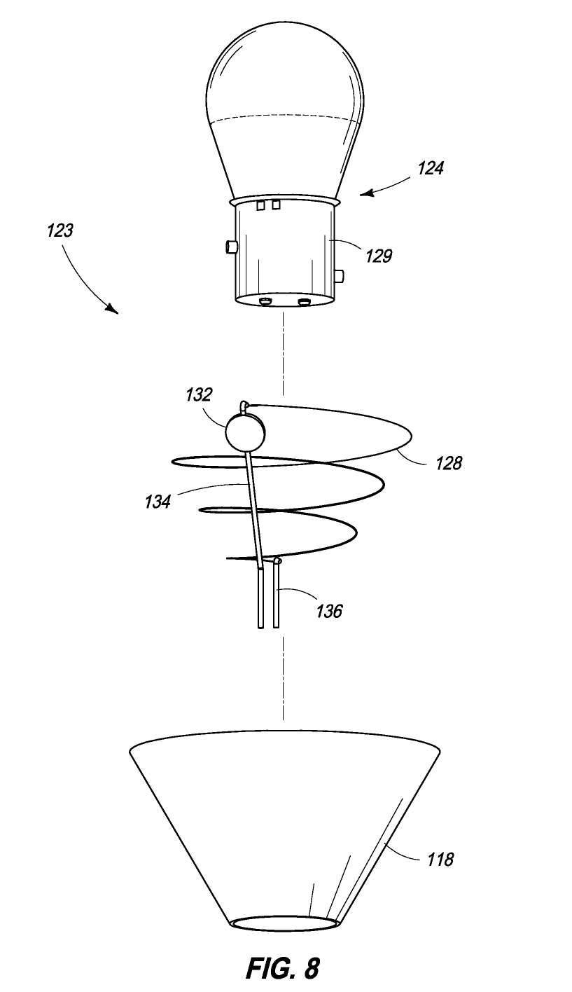

Although shown on a typical vehicle light bulb, it is understood that lamp base 129 can take on any of a number of alternative configurations including bayonet, threaded, or other suitable mechanical couplings that also provide electrical contacts with a light socket or fixture provided on a vehicle or conveyance, or stationary support structure, such as a lamp post. The depiction in FIG. 8 illustrates one typical form of bayonet lamp base 129 with a conical, or frustoconical reflector 118. In one case, reflector 118 is made from an insulating material, such as a plastic, and has a reflective inner coating, such as chrome, on surface 130. Optionally, reflector 118 can be made from any suitable material, including metal or steel, and can take on other suitable shapes including parabolic, or dish-shaped configurations. Optionally, thermistor 132 can be replaced with any other suitable device that limits or prevents overheating when electric current is applied continuously to heating wire 128. Heating wire 128 has an inherent resistance when current flows through, thereby generating heat output. Wire 128 can be constructed from the same materials as wire 28 in FIGS. 1-3.

Although the embodiments depicted in FIGS. 1-3 and 4-8 use incandescent (or halogen) bulbs, in is envisioned that such heated lamp systems can be incorporated on lamps and lighting systems using lower heat output lights (or bulbs), such as fluorescent bulbs, Light Emitting Diode (LED) bulbs, and other forms of energy efficient light output devices. Snow accumulation on such devices is exacerbated due to use of these low energy (and heat) output forms of lighting. For example, the usage of LED lighting on railroad crossing indicator lights and airport runway lights greatly increases the risk of snow and/or ice obstructing the lights during inclement (or winter) weather. Such embodiments help overcome this problem.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

The invention claimed is:

1. A heated lamp, comprising:
a lamp housing;
a lens affixed to the housing defining a chamber there between;
a thermal reflector provided in the housing spaced from the lens;
a heating wire provided between the reflector and the lens;
at least one insulator associated with the reflector and configured to support the heating wire circuitously about the reflector operative to heat the lens responsive to electrical current being delivered through the wire;
a light bulb carried by the housing between the lens and the reflector; and
a thermostat electrically coupled with the heating wire operative to regulate temperature of the heating wire responsive to electrical current being delivered through the wire.

2. The heated lamp of claim 1, wherein the heating wire is spaced from the reflector with the at least one insulator.

3. The heated lamp of claim 1, wherein the reflector comprises a heat shield.

4. The heated lamp of claim 1, wherein the at least one insulator is carried by the reflector.

5. The heated lamp of claim 1, wherein the light bulb comprises a base, and further comprising a socket carried by the housing and configured to removably mate/demate with the socket.

6. The heated lamp of claim 1, wherein the heating wire comprises a circuitous wire carried in conformably spaced and proximate relation from a reflective surface of the reflector.

7. A heated light bulb assembly, comprising:
a bulb having a base configured to be received in a socket of a light fixture;
a thermal reflector carried by the base;
a heating wire provided along an inner surface of the reflector having end portions received within the base and electrically coupled with bulb contacts provided in the base; and
a thermal resistor electrically coupled with the heating wire operative to regulate temperature of the heating wire responsive to electrical current being delivered there through.

8. The heated light bulb of claim 7, wherein the reflector comprises a frustoconical reflector extending outwardly from the base and about the bulb.

9. The heated light bulb of claim 8, wherein the heating wire extends in a helical path substantially conforming with an inner surface of the frustoconical reflector.

10. The heated light bulb of claim 7, wherein the heating wire is spaced from the reflector.

11. The heated light bulb of claim 7, wherein the heating wire generates radiant light energy and the reflector reflects radiant light energy toward the lens operative to heat the lens.

12. The heated light bulb of claim 7, wherein the reflector comprises a heat shield.

13. The heated light bulb of claim 7, wherein the thermal resistor comprises a thermistor.

14. The heated light bulb of claim 7, wherein the base comprises a bayonet base.

15. The heated light bulb of claim 7, wherein a pair of clearance notches are provided on an edge of the base proximate the bulb, and a pair of leads respectively pass through the notches into the base, one lead electrically coupling one end of the heating wire with one contact on the bulb base and another lead electrically coupling another end of the heating wire with another contact on the bulb base.

16. The heated light bulb of claim 15, wherein the thermal resistor comprises a thermistor interposed between the one end of the heating wire and the one lead.
